(19) United States
(12) Patent Application Publication
(10) Pub. No.: US 2002/0064370 A1
(43) Pub. Date: May 30, 2002

(54) Dual deck multimedia device

(76) Inventors: John Berkheimer, Scottsdale, AZ (US); Christopher Chevalier, Tempe, AZ (US); Stephen G.T. Maine, Paradise Valley, AZ (US); Christopher Porter, Scottsdale, AZ (US)

Correspondence Address: Snell & Wilmer L.L.P., One Arizona Center, 400 East Van Buren, Phoenix, AZ, 85004-2202, US

(21) Appl. No.: 09/881,592

(22) Filed: Jun. 14, 2001

Related U.S. Application Data
(60) Provisional application No. 60/211,577, filed on Jun. 15, 2000.
(60) Provisional application No. 60/218,603, filed on Jul. 17, 2000.

(51) Int. Cl. H04N 5/92; H04N 5/781; G11B 27/00

(52) U.S. Cl. 386/52; 386/125

(57) ABSTRACT

The present invention relates generally to a multiple deck multimedia device suitably seamless, that is, transparent to the user, through its interconnection, control, signal routing, multimedia content management, and the like. For example, in accordance with one aspect of the present invention, the multimedia device enables viewing, listening, multimedia searching and fetching, and similar functions while simultaneously providing the ability to record and/or store other multimedia content through a single user interface. Additionally, while the following description is directed to a dual DVD and VCR, in accordance with various alternative embodiments of the present invention, the multimedia device may suitably comprise other sources of multimedia content delivery systems. For example, various analog and/or digital systems including hard disk drives, magnetic tape, alternative optical media, solid state memory and other removable or fixed media may be used. Likewise, any number of these decks may be included into the multimedia device.

### CROSS-REFERENCE TO RELATED APPLICATIONS

This application claims priority to U.S. Provisional Application No. 60/211,577 filed Jun. 15, 2000 and U.S. Provisional Application No. 60/218,603 filed Jul. 17, 2000 both which are hereby incorporated by reference.

### BACKGROUND OF THE INVENTION

1. Technical Field of the Invention

The present invention relates generally to multimedia devices, and, more particularly, to multimedia devices having multiple media decks for various media formats within the same housing.

2. Background of the Invention

Multimedia recording and playback devices have become increasingly useful and popular over the years. This is particularly the case in the arena of commercial use of video and home theater. For example, the video cassette recorder (VCR) has revolutionized the ability to record events (e.g., breaking news, production films, sporting events, etc.) and play those events back at a later time. Likewise, the advent of home video playback devices, such as the VCR and DVD, have provided movie production companies a new “aftermarket” which generates millions in revenues for movies and films which previously were generally only viewable at commercial theaters. The video cassette has enabled the public with the ability to purchase and/or rent copies of their favorite movies and shows for their own use-providing the ability to choose the timing of the viewing of the cassettes at their own discretion.

Similarly, the VCR has provided the ability to record events from sources such as television and cable signals when inconvenient and allow those events to be viewed at a later time. In fact, many VCRs come equipped with their own tuners and automatic on/off timers which allow the user to preset the desired time and station to they wish to record. Thus, the user need not be present to turn the VCR on and off in order to enjoy the benefits of recording and watching shows at a later date.

Additionally, the quality and species of media devices available have developed over the years. For example, with regard to recording quality, VCRs have begun shifting from recording in an analog format to a digital format. The digital recording of events has vastly improved the quality of the recorded events. Similarly, other media devices have become popular over the years. For example, optical storage mediums and players for the same have developed. Examples of such include digital video (or versatile) discs (DVD's), video discs, compact discs, and the like. Likewise, alternative storage systems such as “flash” memory and magnetic mediums (like the “hard disk” found in home computers), have shown promise as video and media storage mediums. Nonetheless, many of these mediums have yet to be workably embodied in media devices.

It is often desirable to interconnect these mediums so that copies of the originally recorded event can be made. For example, one might record and produce a movie and wish to make backup copies should the original be damaged or destroyed. Alternatively, one may wish merely to make copies to sell or give away to others. The advent of digital recording technologies has made such uses especially promising since degradation in quality can be reduced if not eliminated. That is, each copy would be of “master” quality.

However, the logistics of interconnecting the devices is often difficult. Likewise, various laws relating to whether users are legally entitled to make copies have prevented the integrating of all of the variously available media for the recording of events and the playback of the same. Nonetheless, dual deck video cassette recorders (DDVCRs) have been developed. DDVCRs may be generally described as a single home theatre component which contains two video cassette decks. Previously, in order record from one video cassette to another, one would often need to connect two “standard” single deck VCRs through various cabling. Obviously, the VCRs would need inputs and outputs for sending/receiving the signals to be recorded. Such set-ups can be cumbersome and time consuming to use. In contrast, the DDVCR eliminates the need for multiple VCR components. Instead, the DDVCR allows recording from one video cassette deck to the other within the same component. However, DDVCRs still suffer from many drawbacks.

For example, a difficulty which arises with standard VCRs and many DDVCRs is the inability to play back a recorded event from on cassette, while simultaneously recording another event. For example, a user may wish to view an event such as a rented movie. However, the user may also wish to simultaneously record a television show. With only one single deck VCRs (or for that matter, any single deck recording medium), this is impossible. Single deck VCRs require the rented movie to be inserted and played in order to be viewed. Because the cassette is in the only available video cassette carrier, it is impossible to insert a separate cassette for recording the program.

Another unresolved problem is the policing of unauthorized duplications of copyrighted content. For example, duplication of videocassette tapes and DVDs are often attempted by cabling together two single deck VCRs or a DVD player and a VCR.

In attempts to prevent unauthorized copying, copyrighted material is encrypted or copy protected by systems such as CSS and Macrovision™. However, copy decoding systems are being marketed and employed to protect encoded copyrighted material from illegal or unauthorized copying. For example, video copy decoding systems such as de-CSS and “video stabilizer” systems, have been developed to interfere during the copying of copyright encrypted media. The purpose of de-CSS and video stabilizers are to intercept the video signal and unscramble the copy-coding system. Thus, means of preventing stabilizers and copy decoding systems are desirable.

Thus, there is a long felt need for a multimedia device which is easy to use, enables viewing, listening, searching and fetching, and similar functions while simultaneously providing the ability to record and/or store other multimedia content through a single user interface as well as provides the ability to prevent illegal duplication of content.

### SUMMARY

The present invention relates generally to a multiple deck multimedia device suitably seamless, that is, transparent to the user, through its interconnection, control, signal routing, multimedia content management, and the like. For example, in accordance with one aspect of the present invention, the multimedia device enables viewing, listening, multimedia searching and fetching, and similar functions while simultaneously providing the ability to record and/or store other multimedia content through a single user interface. Additionally, while the following description is directed to a dual digital versatile disk (DVD) and VCR (a “DVR”), in accordance with various alternative embodiments of the present invention, the multimedia device may suitably comprise other sources of multimedia content delivery systems. For example, various analog and/or digital systems including hard disk drives, magnetic tape, alternative optical media, solid state memory and other removable or fixed media may be used. Likewise, any number of these decks may be included into the multimedia device.

### DESCRIPTION OF THE DRAWINGS

Additional aspects of the present invention will become evident upon reviewing the non-limiting embodiments described in the specification and the claims taken in conjunction with the accompanying figures, wherein like numerals designate like elements, and:

FIG. 1 is an exemplary embodiment of a multimedia device in accordance with the present invention; and

FIG. 2 is a schematic diagram of an embodiment of a multimedia device in accordance with the present invention.

### DETAILED DESCRIPTION OF EXEMPLARY EMBODIMENTS

The present invention relates generally to a multiple deck multimedia device which is suitably seamless, that is, transparent to the user, through its interconnection, control, signal routing, multimedia content management, and the like. It should be appreciated by one skilled in the art that the following descriptions are of exemplary embodiments of the invention only, and are not intended to limit the scope, applicability or configuration of the invention in any way. Rather, the following description is intended to provide convenient illustrations for implementing various embodiments of the invention. As will become apparent, various changes may be made in the function and arrangement of the elements described in these embodiments without departing from the sprit and scope of the invention.

For example, in accordance with various aspects of the present invention and as described in varying detail herein, the multimedia device enables viewing, listening, multimedia searching and fetching, and similar functions while simultaneously providing the ability to record and/or store other multimedia content through a single user interface. Additionally, while the following description is directed to a DVR, in accordance with various alternative embodiments of the present invention, the multimedia device may suitably comprise other sources of multimedia content delivery systems. For example, the decks of the device may comprise various analog and/or digital systems including hard disk drives, magnetic tape, alternative optical media, solid state memory and other removable or other fixed media. Likewise, any number of these decks may be included into the multimedia device.

In accordance with another aspect of the present invention, the multimedia device may also be connected to virtual devices in network combinations from both local and remote locations such as local area networks (LAN) and wide area networks (WAN), such that content may be provided from locations other than within the multimedia device itself. Such configuration suitably allows a user to watch (and/or listen) and record various analog and digital sources, where a playing device and a recording device (physical or virtual) together create a virtual multiple deck media appliance.

Accordingly, the present invention, in its various embodiments, relates to multiple deck media devices which allow various combinations of interconnection, control, signal routing and management of multimedia content. For example, in a preferred embodiment of the present invention, the system comprises a single component containing a DVD carrier and a video cassette deck. Preferably, DVD and video cassette deck are seamlessly integrated (i.e., transparent to the user) such that, as described herein, a user can switch between the various decks as if the multimedia device comprised only a single source (e.g., a single DVD or a single video cassette deck).

As mentioned above, in accordance with the present invention, the multiple deck media device suitably includes seamless integration of multiple consumer electronic appliance functions through a single front panel, on screen menu or remote control. Additionally, the media device preferably includes the ability to route analog or digital audio or video switching as desired. Still further, the media device preferably allows the copying of audio or video information at a physical layer with or without fully decrypting, decoding, re-encoding source information. For example, preferably there is no need to decode (demodulate) or encrypt source information and then re-encode (re-modulate) the information at the destination device.

Thus, the foregoing combination product allows the user to carry out multiple tasks, such as for example, watching or listening playback from the device while simultaneously recording or searching other information to be viewed or listened at a later time. Additionally, the interconnection of the multiple multimedia devices is performed such that each device is fully knowledgeable about the action of the other, thus suitably preventing any conflicts that could arise between the actions of each device.

In accordance with still another aspect of the present invention, another feature of the present invention is the ability, in the context of, for example, a DVR system, to duplicate the high quality of a DVD or other digital medium with good fidelity as well as avoidance of copy degradation onto a videocassette, recordable DVD or any other recordable medium. For example, a user of a device in accordance with the present invention can, simply and easily duplicate (or dub) content from one source (e.g., a DVD) to a target (e.g., a VHS cassette) through dubbing circuitry to achieve a clear, high-quality, target which is nearly identical, if not indistinguishable, from the original source.

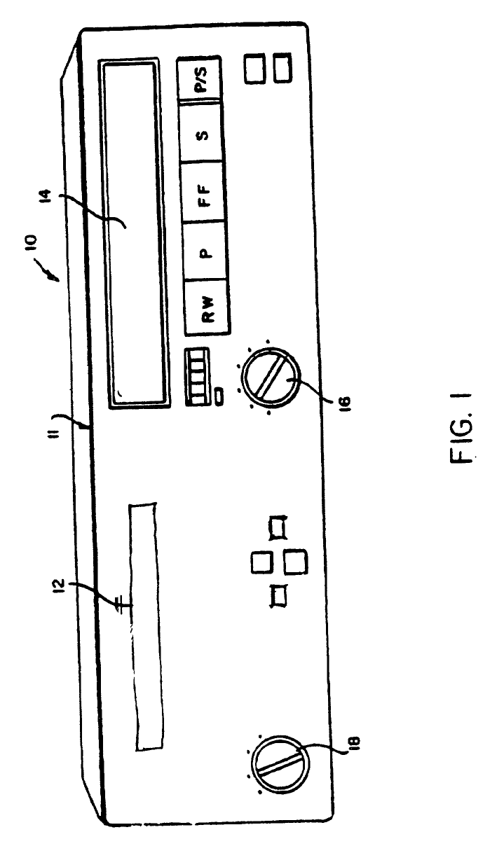

Referring now to the drawings and particularly to FIG. 1, a multimedia device 10 in accordance with an exemplary embodiment of the present invention includes a combined optical disc carrier and video cassette carrier. The system 10 is contained within a single housing 11 and, as will be described, includes a dual deck arrangement for receiving a standard 15 cm optical disc and a conventional video tape cassettes therein. Preferably, both the optical disc deck and the video cassette deck are capable of playing on video monitors (e.g., televisions) or audio outputs (e.g., speakers or headphones) as desired.

For example, a first deck 12 is preferably an optical disc carrier suitable for playing DVD format discs. Additionally, in accordance with various aspects of the present invention, carrier 12 is also suitably configured to play any combination of a variety of other optical disc formats such as audio CDs (including CD-R, CD-RW, DVD-R, DVD-r/w, DVD-r+w, DVD-ROM, DVD-RAM, DVD-audio, etc.), photo CDs, CD-Roms, CD-ROM/XA, CD-3, CD-CA, CD-I, video CD, super CD-video (SCDV), micro optical disc (such as DataPlay™) and other now known or as yet unknown formats. Likewise disc carrier 12 need not be limited to 15 cm discs, but rather may be substituted with any size/format disc which may be available. Additionally, other mediums and formats, not necessarily optical disc, may be substituted in the present invention. Non-limiting examples of such mediums include removable and non-removable hard drives and formats include WMA, MP3, AAC, MPEG-1, MPEG-2, MPEG-4, WAVLET and others.

In accordance with various aspects of the present invention, a second deck 14 is preferably a video cassette deck, and most preferably a VHS video cassette deck. Of course it should be noted that any cassette medium may substituted (such as S-VHS, Hi-8, 8 mm, Beta, BetaCam, MDV, DV, Digital-S, DVCam, DVC-pro, BetaCam SP or the like) and, moreover, other mediums and formats discussed above with respect to first deck 12 may be substituted in various embodiments of the present invention. In the present exemplary embodiment, video cassette deck 14 is capable of both playback on a monitor as well as recording from various sources such as from first carrier 12 and/or other video sources such as cable, satellite, Internet and broadcast sources. Additionally, video cassette deck 14 is optionally configured for VHS for playback and recording in hi-fi Stereo or monaural and may have any number of recording/playback heads (in the present exemplary embodiment, four).

In accordance with another aspect of the present invention, device 10 has selectable switching capabilities for switching various input and output signals to, from and between decks 12 and 14, including between decks 12 and 14 and/or output from any of the decks or a tuner to a desired monitor. For example, in an exemplary embodiment, an output selection switch is provided for selection of the output to a monitor (such as a video monitor or audio system) from among a plurality of signals including the output signal from any of the of media decks and various inputs to any of the media decks. Other standard signals which are selectively directed through the output selection switch might include a tuner, a video line, content from the Internet, a camera or otherwise. Particularly, in accordance with the present invention, tuner can comprise any device capable of providing an external signal to device 10. Non-limiting examples include SAT, ATSC, NTSC, CATV, Digital Cable, AM/FM or other tuners now known or as yet unknown in the art.

In accordance with various embodiments, a second selection switch may also be provided for selecting the desired recording input. For example, in accordance with an exemplary embodiment of the present invention, one of the lines connected to this switch is suitably connected directly to a video cassette deck capable of recording. A cassette in this deck can record content from the first deck (e.g., a DVD deck) while viewing other content on a video monitor.

More particularly, in accordance with one embodiment of the present invention, an output selection switch 16 is provided for selecting the source and location for output from device 10. For example, in the present exemplary embodiment, switch 16 is located on the front of housing 11 below deck 14. Of course other locations of switch 16 are equally within the scope of the present invention, so switch 16 may be located in other areas on housing 11, or even on a remote control (not shown). Preferably, switch 16 is capable of selecting the line which will be connected to the output (video monitor or speakers) for viewing and listening to media played by device 10.

With continuing reference to FIG. 1, a recording switch 18 may also located on the front of housing 11 and is provided for selecting the input line from which a program or prerecorded material will be recorded onto a blank video tape cassette in deck 14. In various embodiments, recording switch 18 may also be capable of providing “one-touch” recording of media from deck 12 to deck 14. For example, upon insertion of a DVD in deck 12 and a blank cassette in deck 14, upon the single touch of switch 18, device 10 will automatically begin copying the content from the DVD to the video cassette. In accordance with various aspects of the present invention, copying can be done at any speed, including normal play speed as well as high speed dubbing. Likewise, depending on the type of decks used, copying between decks may be bi-directional. That is, in an embodiment of device 10 having combinations of hard disk drives (removable or non-removable) recordable optical discs, micro optical or solid-sate memory decks recording can be performed either first deck 12 to second deck 14 or vice versa, from second deck 14 to first deck 12. Additionally, device 10 may be suitably configured such that a user of device 10 can selectively monitor the dubbing of the DVD to the cassette, through, for example, a television monitor.

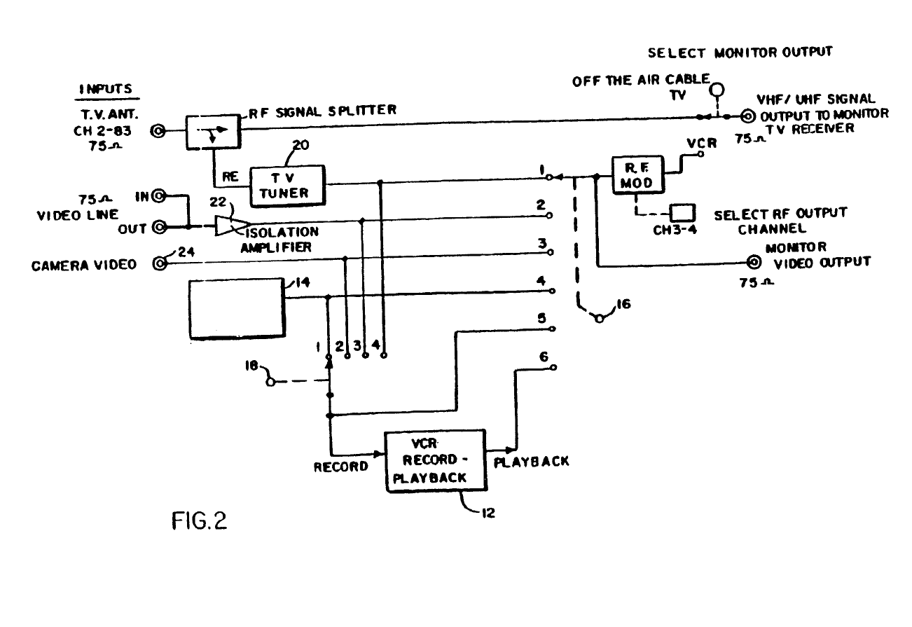

With reference now to FIG. 2, in accordance with further aspects of the present invention, device 10 may be used for not only playing a prerecorded media such as video cassette tapes and DVDs, but also may be used for recording onto a blank video tape cassette. Preliminarily, it should be appreciated that the electrical components shown in FIG. 2 are composed of conventional circuitry and may be embodied in many forms. That being said, in the present exemplary embodiment, the electrical inputs into the system include a TV signal that is directed through a TV tuner 20, a video input that is directed through an isolation amplifier 22, another input socket 24, and the optical disc carrier and video cassette carrier.

The input signals may be selectively directed into cassette deck 14 for recording onto a blank tape located therein. Switch 18 selects the input for which input is to be recorded onto the blank tape from among the multiple input lines. In accordance with various aspects of the present invention, the input signals may also (or alternatively) be directed to a video monitor for display or speakers for audio playback. To direct the input, output selection switch 16 is toggled through its various switch positions to an appropriate position for the various input signals. Likewise, switch 18, through its various switch positions, may be used to select an input line to the first deck 12 for direct connection to the TV monitor. At the video monitor (or speakers), conventional means known to those skilled in the art may be used for selecting the appropriate output channel for displaying the signals received through the output selection switch 16.

Of course it should be appreciated that though described as two distinct switches herein, it should be appreciated that switches 16 and 18 may be embodied in any number of ways, including as only one switch or more than two switches, in many different locations. However, in any embodiment, the functionality of selection switches 16 and 18 as realized in the present invention, enables a versatility of operation that is not present in any known single deck multimedia devices or, for that matter, any known dual deck multimedia systems. That is, by utilizing device 10 in accordance with the present invention, it is to perform various functions such as viewing, listening, multimedia searching and fetching content, and similar functions while simultaneously providing the ability to record and/or store other multimedia content through a single user interface.

Thus, selectable switching in accordance with the present invention allows, among other functions, extracted off-the-air video/audio to be directed to one deck, while independently connecting the deck to a television receiver via a modulator and output jack. Additionally, it enables connectivity of the decks directly for dubbing from one to the other without passing the source signal through an R.F. modulator in the course of dubbing, while independently allowing direct transmission of other signals to the television receiver via the housing without passage through the tuner and modulator within the housing or with passage of the antenna signal or the source signal through the modulator within the housing. Further still, auxiliary input or output jacks are provided to decks 12, 14 which allow the opposing deck to be connected to another auxiliary jack or to the television receiver via the modulator.

For example, selection switch 18 can record either a TV program through tuner 20 connected to a position on switch 18, a video input connected to another position on switch 18 position, or any other input connected to a position on switch 18. At the same time, prerecorded media content from either deck 12, 14 can be viewed on a video monitor or speakers. Additionally, device 10 in accordance with the present invention enables the duplication of material from either deck 12, 14 onto the opposing deck while at the same time displaying the prerecorded program. One aspect of this function is that the prerecorded material can be edited as it is copied to the opposing deck.

Now, in accordance with another aspect of the present invention, a user interface is provided for interacting with device 10. As mentioned above, preferably, user interface is singular in nature; that is, it is seamless/transparent to the user that device that the device may comprise more than one source of content. In an exemplary embodiment, user interface comprises an onscreen display (OSD) which interacts with a user control, such as a multibutton/function remote control, a keyboard, mouse or other input device.

In accordance with another aspect of the present invention, commands can be sent or originated through a local or remote network which uses the OSD or the remote control device. For example, infrared, wired or wireless remote controllers can be used as network devices as they often require a predetermined protocol which generally does not conflict with other infrared or wireless devices activated in the same vicinity. In the present exemplary embodiment, interfacing may be accomplished through a “joystick” type remote, optionally having glow-in-the-dark keys controls for both decks 12, 14.

In accordance with yet another aspect of the present invention, optionally, a further feature of the invention is the maintenance of the integrity of pre-encoded copyright protection systems in a manner that makes defeat of protection systems by ordinary consumer devices (generally referred to as “video stabilizers” or “black boxes”) impracticable. For example, the editing and duplication using device 10, is accomplished through the internal circuitry of the system in such a manner that any attempts by a user to intercept the video signal through external cabling will be unsuccessful for a variety of reasons. First, an external signal would have to pass through the demodulation-modulation process and would not be of original high quality for duplication process. Second, copy coded prerecorded media (e.g., a Macrovision™ encrypted DVD) is suitably read by a sealed integrated circuit within the “playing” decks electronic circuitry which instructs the “recording” deck to scramble or not record the signal. Third, the video stabilizer cannot be plugged into the sealed integrated circuits of device 10 without substantial engineering, tooling and/or cost.

Lastly, many other features may be incorporated with a multiple deck device in accordance with the present invention. For example, device 10 may be suitably configured with various features such as a 10-bit video digital to analog converter, a 27 MHz advanced digital filter, the ability to playback of 96 kHz/24-bit sources, a Dolby Digital 5.1 channel Surround Sound decoder, a DTS digital output for DTS-enhanced DVDs and continued audio during 2× speed playback. Additionally, auto setup for automatically setting a clock and channel searching may be provided. A/V switching between TV and VCR/DVD decks and a “TV view button” may be provided. Further still, specialty connections such as composite, S and Component Video outputs for high connectivity and optimum performance as well as headphone jack and volume control and cable box controls for hookup and control of a user's cable box may also be provided.

More specific VCR controls might include, VCR Plus+™, playback of S-VHS tapes at better than standard resolution, a VISS Index and Search/Scan, Zero Return, Direct Time Search, and Blank Search functions. Likewise multiple event/multiple year timer recording with time remaining and real time counters may also be provided.

Finally, while the principles of the invention have been described in illustrative embodiments, many combinations and modifications of the above-described structures, arrangements, proportions, the elements, materials and components, used in the practice of the invention, in addition to those not specifically described, may be varied and particularly adapted for a specific environment and operating requirement without departing from those principles.

We claim:

1. A multiple deck media device, comprising:
a housing;
a first deck within said housing;
a second deck within said housing;
wherein said first deck and said second deck are independently operable;
an output connectable to a monitor; and
a switch for selectively connecting said first deck and said second deck for copying content between said first deck and said second deck, wherein said output displays one of a signal from said first deck, said second deck and an external input.

2. The multiple deck media device of claim 2, further comprising a tuner.

3. The multiple deck media device of claim 3, wherein said external input is provided through said tuner.

4. The multiple deck media device of claim 1, wherein said first deck is an optical disc carrier.

5. The multiple deck media device of claim 4, wherein said optical disc carrier is a DVD carrier.

6. The multiple deck media device of claim 4, wherein said optical disc carrier can play MP3, WMA, MP3, AAC, MPEG-1, MPEG-2, MPEG-4, WAVLET, CD-R, CD-RW, DVD-audio, photo CDs, CD-Roms, video CD formats.

7. The multiple deck media device of claim 1, wherein said first deck is a hard disk drive.

8. The multiple deck media device of claim 7, wherein said hard disk drive is removable.

9. The multiple deck media device of claim 1, wherein said second deck is a video cassette deck.

10. The multiple deck media device of claim 9, wherein said video cassette deck is a VHS cassette deck.

11. The multiple deck media device of claim 9, wherein said video cassette deck is at least one of a VHS cassette deck, S-VHS, Hi-8, 8 mm, Beta, BetaCam, MDV, DV, Digital-S, DVCam, DVC-pro, BetaCam SP.

12. The multiple deck media device of claim 1, wherein said second deck is a hard disk drive.

13. The multiple deck media device of claim 12, wherein said hard disk drive is removable.

14. The multiple deck media device of claim 1, wherein said first deck is a recordable optical drive.

15. The multiple deck media device of claim 1, wherein said first deck is a micro optical drive.

16. The multiple deck media device of claim 1, further comprising a single user interface to control said first deck, said second deck and said tuner, wherein such control allows the selection of an output from any of said first deck, said second deck and said tuner.

17. The multiple deck media device of claim 1, further comprising an electronic program guide for connection to a content network.

18. The multiple deck media device of claim 1, wherein said switch selectively connects: an extracted off-the-air video/audio signal to said first deck and independently connects said second deck to a television receiver via a modulator and output jack, (2) said second deck to said first deck directly for dubbing a played out video/audio source signal from said first deck to said second deck without passing said video/audio source signal through an R.F. modulator in the course of dubbing, while independently allowing direct transmission of an antenna signal to said television receiver via said housing without passage through a tuner and modulator within said housing or with passage of said antenna signal or said source signal through said modulator within said housing, and (3a) auxiliary jacks to said first deck while allowing the said second deck to be connected to another one of said auxiliary jacks or to said television receiver via said modulator, (3b) input jacks to said first deck while allowing said second deck to be connected to said television receiver via said modulator.

19. A DVR, comprising:
a housing;
a DVD deck;
a video cassette deck;
wherein said DVD deck and said video cassette deck are independently operable;
an output connectable to a monitor; and
a switch for selectively connecting said DVD deck and said video cassette deck for copying content between said DVD deck and said video cassette deck, wherein said output displays one of a signal from said DVD deck, said video cassette deck and an external input

20. A multimedia device, comprising:
a housing;
a DVD deck;
a hard drive;
wherein said DVD deck and said hard drive are independently operable;
an output connectable to a monitor; and
a switch for selectively connecting said DVD deck and said hard drive for copying content between said DVD deck and said hard drive, wherein said output displays one of a signal from said DVD deck, said hard drive and an external input.
